(19) United States
(12) Patent Application Publication
(10) Pub. No.: US 2005/0126982 A1
(43) Pub. Date: Jun. 16, 2005

(54) Membrane module having fiber breakage protection

(76) Inventors: David Michael Stachera, Brantford (CA); Mailvaganam Mahendran, Mississauga (CA); Hamid R. Rabie, Mississauga (CA); Francois Yacoub, Oakville (CA); Robert William Langerak, Burlington (CA)

Correspondence Address: BERESKIN AND PARR, 40 KING STREET WEST, BOX 401, TORONTO, ON, M5H 3Y2, CA

(21) Appl. No.: 11/000,898

(22) Filed: Dec. 2, 2004

Related U.S. Application Data
(60) Provisional application No. 60/528,493, filed on Dec. 11, 2003.

(51) Int. Cl. B01D 63/06

(52) U.S. Cl. 210/321.88; 210/321.89; 210/321.61; 210/500.23

(57) ABSTRACT

An assembly of potted filtering hollow fiber membranes has at least one bundle of permeating hollow fiber membranes that is potted in a block of potting material, and a cushioning wall extending along at least a portion of the axial length of the membranes adjacent the potting material and around at least a portion of the perimeter of the bundle. The cushioning wall can have a fixed edge adjacent the resin, and the wall can extend away from the resin in a direction generally parallel to the axis of the hollow fiber membranes. Walls of various structures including soft solid materials, non-permeating membranes and fabrics are described.

This is an application claiming the benefit under 35 USC 119(e) of U.S. Provisional Patent Application Ser. No. 60/528,493, filed Dec. 11, 2003. U.S. Ser. No. 60/528,493 is incorporated herein, in its entirety, by this reference to it.

### FIELD OF THE INVENTION

This invention relates to membrane modules for water treatment.

### BACKGROUND OF THE INVENTION

Hollow fiber membranes can advantageously be used in water treatment units to extract permeate from a supply of water. The hollow fiber membranes may be potted in headers. A source of suction is provided to the headers to withdraw permeate through the membrane walls and into the lumens of the fibers. The permeate is then drawn into a permeate collection cavity in or adjacent to the headers.

Immersed membranes may be used for extracting clean water (permeate) from a tank of contaminated water containing solids or mixed liquor. The membranes are often provided in the form of assembled modules, each module having many hollow fiber membranes extending from a header for collecting permeate that passes through pores of the membrane walls into the lumens of the membranes. Streams of air bubbles may be provided in the tank to rise past the membranes for cleaning purposes. The air bubbles also help to create circulation patterns in the tank.

However, the air bubbles or circulating water in the tank apply forces to the membranes. These forces may cause the fibers to break. A broken fiber allows unfiltered water from the tank to enter the permeate collection cavity. Since this is undesirable, the broken fiber must be located and repaired resulting in loss of productivity and additional expense.

### SUMMARY OF THE INVENTION

It is an object of the invention to improve on, or at least provide a useful alternative to, the prior art. It is another object of the present invention to provide a membrane module of hollow fiber membranes and a method of making such a membrane module or a method of potting hollow fiber membranes. It is another object of the present invention to provide a membrane module having hollow fiber membranes that are protected, or have been potted, to inhibit their breakage. The following summary provides an introduction to the invention but is not intended to define or limit the invention which may reside in a combination or sub-combination of features provided in this summary or in other parts of this document for example the claims.

When using immersed membrane modules, the fiber membranes can sway or vibrate back and forth. The inventors have observed that this motion can induce some stress in the fibers, particularly near the headers where the fibers exit the potting material which seals and secures the outsides of the membranes, and particularly in fibers positioned at the outer periphery of any particular bundle of potted fibers. As a result, the fibers at the outer periphery of a bundle of fibers, and any stray fibers sticking out from a bundle of fibers into a circulation channel for the water in the tank, are particularly susceptible to breakage. By protecting even only these fibers, the rate of breakage in the bundle may be drastically reduced. Alternately, a thinner or weaker, but less expensive, fiber may be used and result in the same breakage rate as a strong fiber that is not so protected.

According to one aspect of the present invention, an assembly of hollow fiber membranes has at least one bundle of permeating hollow fiber membranes that are potted in a block of solid potting material, and a cushioning wall extending along at least a portion of the axial length of the fibers adjacent the potting material around at least a portion of the perimeter of the bundle. The portion of the perimeter may be an area where forces on the fibers from bubbles or circulating water are highest. Optionally, the entire perimeter may be protected.

The cushioning wall can have a fixed edge adjacent the potting material, and the wall can extend away from the potting material in a direction generally parallel to the length of the hollow fiber membranes. The wall may extend away from the potting material for only a short distance, for example, less than 15 cm, since the need for protection is primarily where the fibers join the potting material. If the potting material has wicking asperities with upper edges extending away from the potting material, and the cushioning wall can extend past the upper edges of the wicking asperities. The cushioning wall can be attached to the potting material of the header. Alternately, the header can be provided with a shell in which the potting material is held, and the cushioning wall can be attached to the shell.

The cushioning wall can have a free edge opposite the fixed edge. The cushioning wall can comprise a layer of liquid material solidified after application to the potting material or shell. Alternatively, the cushioning wall can comprise a strip of flexible material applied as a solid and the fixed edge can be attached to or potted in the potting material.

In other aspects, protective or non-permeating fibers can be added to a bundle to form a cushioning wall protecting the other fibers. For example, a layer of protective fibers of generally the same length as the other bundled fibers, may be provided on the outside of a bundle, either in one or more selected high stress locations, or around the entire perimeter of the bundle. The layer of protective fibers can include non-permeating hollow fibers, with ends that terminate and are embedded within the potting material. Alternatively, the non-permeating hollow fibers can have fluid isolating obstructions within the fibers, between the ends of the non-permeating fibers and where the non-permeating fibers exit the potting material. The fluid isolating obstructions can be plugs or pinch seals. Because the fibers are non-permeating they may break without allowing water in the tank to enter the permeate collection cavity. But even when broken, the protective fibers continue to protect the other fibers in the bundle from breakage. As a further alternative, the layer of protective fibers can include non-permeating solid filaments. The solid filaments can have at least an outer layer of fiber material that is generally the same as the material from which the permeating hollow fiber membranes are constructed or be of such a material throughout. As yet a further alternative, the layer of protective fibers can comprise reinforced permeating fibers having ends potted in the cured resin. The reinforced hollow fibers can be hollow fibers supported on a braided tube.

The layer of protective fibers can additionally or alternatively include a porous fabric sheet. The fabric sheet can be constructed of, for example, but without limitation, cheesecloth or gauze or other macroporous fabric constructions, and can extend along substantially the entire axial length of the bundled permeating hollow fibers.

In another aspect of the present invention, a method of constructing a header having potted filtering hollow fiber membranes and breakage protection for the membranes is provided. The method includes providing a bundle of permeating hollow fiber membranes inside a header shell or other potting container in a first layer of potting material and providing a cushioning wall along at least a portion of the axial length of the fibers and along at least a portion of the perimeter of the bundle to reduce stress on the fibers where the fibers exit the resin and to prevent stray fibers from sticking out beyond the periphery of the bundle.

The cushioning wall can be provided around substantially the entire perimeter of the bundle. Providing the wall can include applying a liquid along a portion of the perimeter of the bundle which is to have the wall and allowing the liquid to solidify in contact with the potting material or shell. Alternatively, the cushioning wall can be in the form of a strip of solid flexible material having a first edge positioned to generally abut the first layer of potting material, and the method can include supplying a second layer of potting material to pot the first edge of the cushioning wall, fixing the first edge of the cushioning wall to the header.

In another aspect of the present invention, a method of potting hollow fiber membranes in a header that controls against potting stray fibers is provided. The method includes arranging a plurality of hollow fiber membranes in a bundle, providing gathering elements around the perimeter of the bundle of fibers and/or adjacent one end of the bundle and providing a solidifying potting material such that the potting material flows between adjacent fibers in the bundle.

The gathering elements can be substantially inelastic, and can be provided between groups of fibers in each bundle to form sub-bundles. The gathering elements can comprise, for example, but not limited to, string-like elements such as fiber membranes, filaments, or yarn. The method for providing the gather elements can include threading, stitching, or weaving the gathering elements in a matrix pattern around and/or through the bundle, in a plane generally perpendicular to the axis of the fibers.

### BRIEF DESCRIPTION OF THE DRAWINGS

For a better understanding of the present invention and to show more clearly how it may be carried into effect, reference will now be made by way of example, to the accompanying drawings that show embodiments of the present invention, and in which:

FIG. 1 is a perspective view of a filtration module according to the present invention;

FIG. 2 is a top view of a header portion of the module of FIG. 1;

FIG. 3 is an enlarged cross-sectional view of a portion of the header of FIG. 2 cut in a vertical plane;

FIG. 4 is another view of FIG. 3 showing a fugitive material for a process for potting the header of FIG. 2;

FIG. 5 is an enlarged view of a header portion of the module of FIG. 1;

FIG. 6 is a cross-sectional view of a portion of the header of FIG. 5;

FIG. 7 is a similar view as FIG. 6 for an alternate header embodiment;

FIG. 8 is an end view of an alternate module embodiment with a further alternate header embodiment;

FIGS. 9a and 9b are partial cross-sectional views of the header of FIG. 8 showing alternate embodiments of a protective layer of non-permeating fibers;

FIG. 10 is a cross-sectional view of an alternate non-permeating fiber for use with the header of FIG. 8;

FIG. 11 is a cross-sectional view of an alternate protective layer for use with the header of FIG. 8;

FIG. 12 is a perspective view of a further alternate protective layer for use with the header of FIG. 8; and

FIG. 13 is a plan view of a lower part of a bundle of fibers with gathering elements, the bundle cut in a horizontal plane.

### DETAILED DESCRIPTION OF THE INVENTION

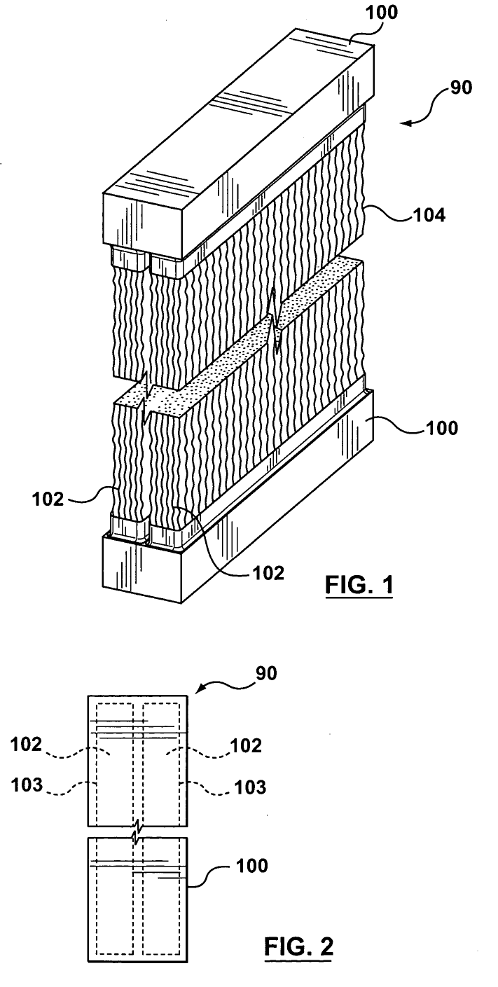

A filtration module 90 having a header potted according to the present invention is shown generally in FIG. 1. The module 90 has opposed headers 100 and at least one bundle 102 of permeating hollow fiber membranes 104 extending between the headers 100. In the embodiment illustrated, the module 90 has two bundles 102. Each bundle 102 is configured in an elongate rectangular shape when viewed from above (FIG. 2), so that each bundle has a generally rectangular perimeter 103 (shown in phantom line) in a plane perpendicular to the axis of the hollow fiber membranes. The two bundles 102 are arranged in parallel in the header 100. Other configurations, such as, for example and without limitation, modules with a single header at one end of the bundles, modules with only one bundle of fibers, and headers/bundles with circular perimeters can also be provided within the scope of the present invention.

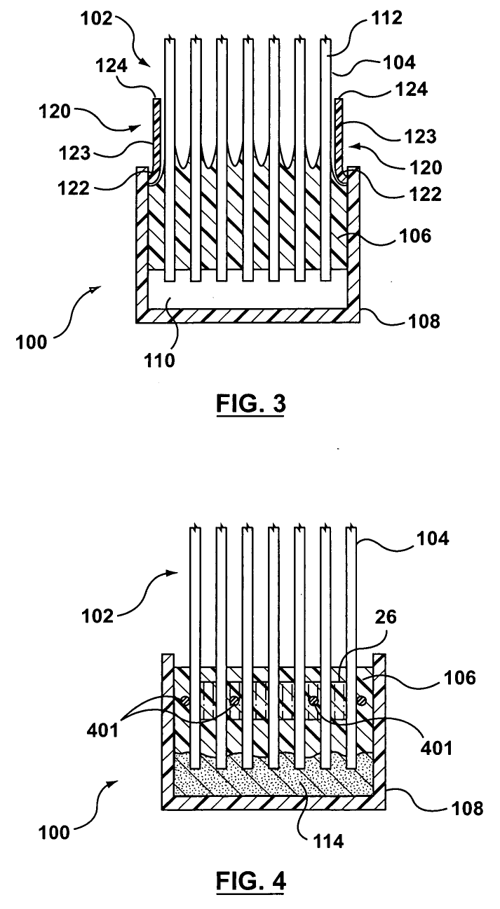

As best seen in FIG. 3, showing a portion of the header 100 holding one bundle 102, each header 100 is provided with a block of potting material, such as a cured resin 106, in which the hollow fibers 104 are potted such that they are attached to the potting material and sealed such that water to be filtered does not contaminate the permeate. The resin 106 can hold the hollow fiber membranes 104 in a generally closely packed, but spaced-apart, relationship, to provide a desired fiber potting density.

The header 100 can have a shell 108, and the resin 106 can fill an upper portion of the shell. A permeate cavity 110 is provided between the underside of the resin and the inner surface of the shell. The permeating fibers 104 have lumens 112 that are in fluid communication with the permeate cavity 110. The resin 106 serves to hold and seal the fibers of the bundles in the shell, and to seal off the permeate cavity 110. In a module 90 with two headers 100, one header 100 can be a non-permeating header with the resin 106 filling the shell 108 entirely, that is the area occupied by the permeate cavity 101 in FIG. 3 is filled with resin 106.

Referring to FIG. 4, the cavity 110 can be formed, for example, by providing a fugitive material 114 inside a lower portion of the shell 108, then pouring the resin 106 on top, allow resin 106 to cure, and then removing the fugitive material 114. This and other processes for potting that may be used with the present invention are described further in U.S. Pat. No. 6,592,759, which is hereby incorporated in its entirety by this reference to it. Alternatively, other methods of potting the fibers may be used. For example, the ends of the fibers may be placed in liquid resin in a container. The resin is allowed to cure around the fibers, optionally while the fibers and container are centrifuged. The resin is then cut to open the ends of the fibers, and the block of resin, optionally with part of the walls of the container still attached, is glued into a header shell.

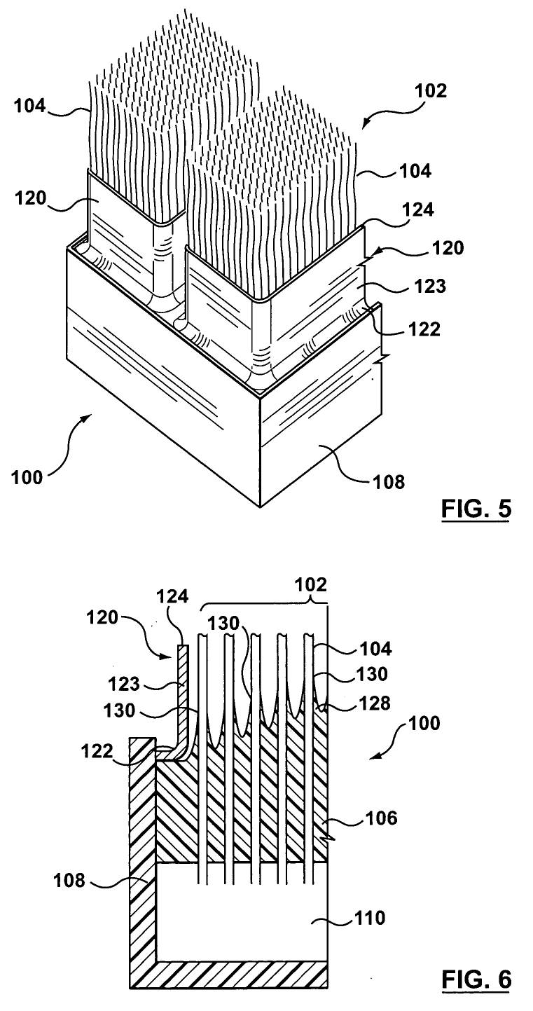

Referring now to FIGS. 3 and 5, the header 100 is further provided with a cushioning sidewall 123 that extends along at least a portion of the perimeter 103 (FIG. 2) of each bundle 102, and along at least a portion of the axial length of the membranes 104 adjacent the cured resin 106. The cushioning sidewall 123 can be provided by a flexible protective strip 120 having a lower edge 122 adjacent the resin 106, and an upper edge 124 opposite the lower edge 122. The lower edge 122 can be attached to the resin 106. As the fibers 104 sway back and forth, the outermost fibers 104 can press against the cushioning sidewall 123, thereby reducing and/or distributing the stresses on the fibers 104. The sidewall 123 may also keep fibers that would otherwise stray, close to the rest of the bundle. This can reduce breakage of the fibers 104, particularly at the point where the fibers exit the resin 106. The sidewall 123 can be provided along portions of the perimeter 103 of each bundle 102 where potentially damaging forces are experienced. As an example, in bundles as shown in FIGS. 1 and 2 having a rectangular perimeter with a major (longer) axis and a minor (shorter) axis, and the membranes 104 being oriented horizontally when in use, the sidewalls 123 can be provided along the sides of the perimeter 103 parallel to the major axis. Alternatively, the sidewalls 123 can be provided around the entire perimeter 103. The sidewalls 123 need not be of a continuous, solid extent, but can have, for example, but not limited to, apertures, openings, or gaps.

Referring to FIGS. 3 and 6, in certain potting processes, the exposed surface of the resin 106 can present wicking asperities 128 having upper edges 130 that extend away from the main volume of the resin 106. The wicking asperities are generally formed as a result of capillary action or other surface effects of the liquid resin along the outer surface of the hollow fiber membranes 104. The resin typically hardens to form a relatively hard, non-compliant material compared to the membrane material. The inventors have observed that the likely point of breakage of the outermost fibers 104 in the bundle 102 is near the point along the length of the fibers 104 where the upper edges 130 of the asperities 128 extend. To improve the cushioning effect of the wall 123, the cushioning sidewall 123 can be provided along an axial extent of the membranes 104 that extends beyond the upper edges 130 of the asperities 128. In the illustrated embodiment, the strip 120 has a lower edge 122 that is attached to the resin 106, and an upper edge 124 that extends past the upper edges 130 of the wicking asperities 128.

The material of the strip 120 can be any flexible material that is able to yield to a force exerted on it by a fiber 104 that may be attached to, or pressed against, the wall 123, while providing some resistance to such force so that any stress induced on the fiber 104 at its point of exit from the resin 106 is reduced. Furthermore, the strip 120 should be sufficiently soft and/or smooth so that any rubbing action that may occur between the strip 120 and the fibers 104 does not damage the fibers 104.

In the embodiment illustrated, the strip 120 is formed of a silicone material that is applied in a generally liquid form around the perimeter 103 of each bundle 102, near the resin 106. The silicone solidifies to form the flexible strip 120. The lower edge 122 of the strip 120 so formed bonds to an exposed surface of the header 100, which can include at least one of the surfaces consisting of the resin 106 and the shell 108. The silicone may also bond to the membranes 104, although that bond may be broken as the membranes move in service.

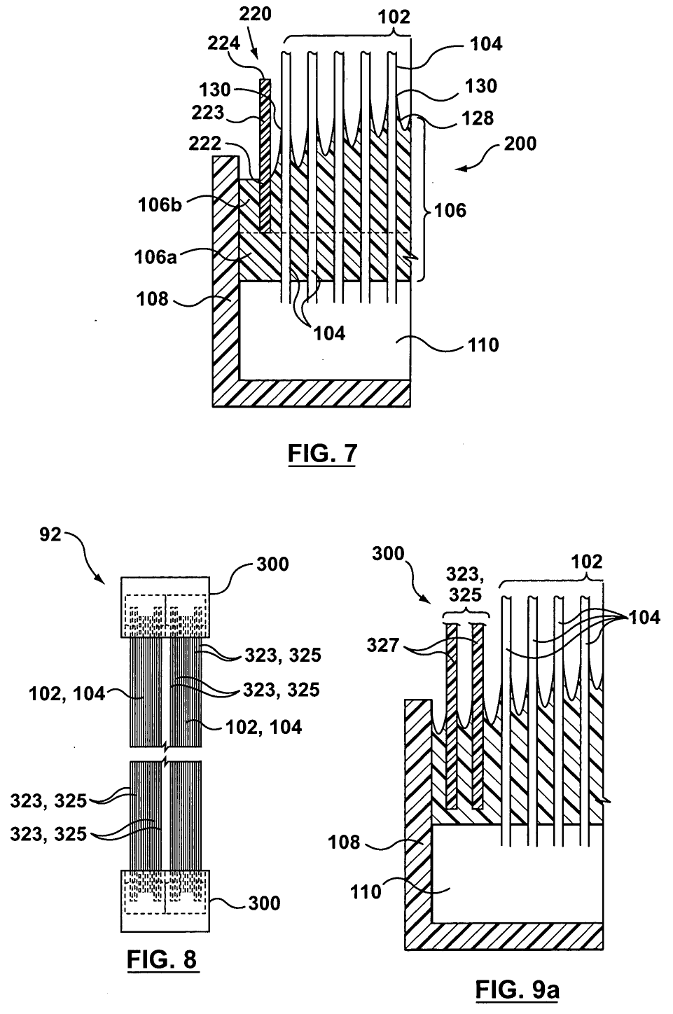

Another embodiment of a header 200 according to the present invention is best seen in FIG. 7. The header 200 has bundles 102 of hollow fibers 104 potted in resin 106 in a rectangular configuration, and a cushioning wall 223, provided by a protective strip 220, that extends around the perimeter 103 of the bundles 102. The cushioning wall 223 extends axially along at least a portion of the axial length of membranes 104 adjacent the cured resin. The strip 220 comprises a solid strip of flexible material having a lower edge 222 that is potted in the resin 106 of the header 200. The material can be, for example, but not limited to, a strip of flexible plastic or rubber.

To facilitate construction of the header 200, a two-stage potting process can be employed. The bundle is prepared with the protection strip 220 wrapped around one end. The protective strip 220 may have a circumference the same as or slightly longer than the circumference of the bundle to inhibit fibers from straying from the bundle. The lower ends of the fibers 104 in the bundle 102 can be potted in a first layer of resin 106a. The lower edge 222 of the strip 220 can then be positioned along the perimeter 103 of the bundle 102 and against the upper surface of the resin layer 106a, and a second, final layer of resin 106b can then be provided on top of the first layer 106a and around the lower edge 222 of the strip 220. The layers 106a and 106b together form the cured resin 106 of the header 200, and hold the fibers 104 and the strip 220 securely in place. Alternatively, one or more strips 220 may be provided only at selected locations, for example along the two long sides of a bundle, and inserted into the resin before it cures, or provided on top of a first layer 106a as described above.

In the embodiment illustrated, the strip 220 of the header 200 has an upper edge 224 opposite the first edge 222, and the cushioning wall 223 extends between the edges 222 and 224. The resin 106 has wicking asperities 128 with upper edges 130 extending away from the exposed surface of the resin 106 and adjacent the fibers 104. The upper edge 224 of the strip 220 extends past the upper edges 130 of the wicking asperities 128. Accordingly, the cushioning wall 223 straddles the axial position of the upper edges 130 of the wicking asperities 128 along the bundle 102. The wall 123, 223 may be, for example, between 1 cm and 15 cm high.

A third embodiment of a header according to the present invention is illustrated at 300 in FIG. 8. In the embodiment illustrated, two opposed headers 300 are shown as part of a filtration module 92. Each header 300 has two bundles 102 of permeating hollow fiber membranes 104 potted in resin 106, and a cushioning wall 323 around a portion of the perimeter of each bundle 102. The cushioning wall 323 extends axially along substantially the entire length of the fibers 104 in the bundle 102 and is potted in both headers 300.

The cushioning wall 323 can be provided in the form of a protective layer 325 of non-permeating fibers 327. The non-permeating fibers 327 are fibers that do not provide fluid communication between an external surface of the fibers and the permeate cavity 110 in the header 300. The non-permeating fibers 327 may be potted in the resin 106, around at least a portion of the perimeter 103 of each bundle 102 of fibers 104, and may be potted at a spacing or potting density generally equal to that of the permeating fibers 104 in the bundle 102. The protective layer 325 may comprise about one to five or two to three rows of fibers 327 in thickness. In the embodiment illustrated, the protective layer 325 comprises two rows of non-permeating fibers 327.

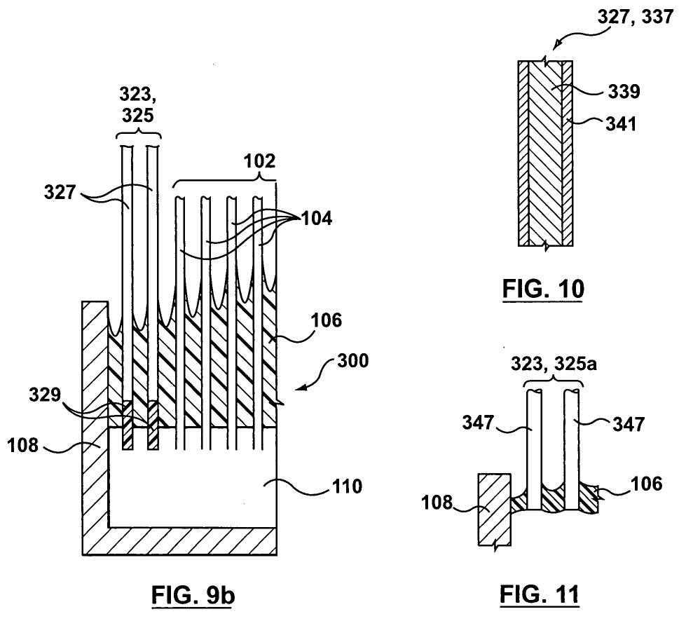

Referring to FIG. 9a, the non-permeating fibers 327 of the protective layer 325 can comprise additional hollow fibers of generally the same construction as the permeating hollow fibers 104, but potted so that the lumens of the fibers 327 are fluidly isolated from the permeate cavity 110. This fluid isolation can be provided by embedding the ends of the non-permeating fibers 327 within the resin 106. In other words, the non-permeating fibers 327 can be shorter than the permeating fibers 104 so that the non-permeating fibers 327 terminate within and do not pass through the resin 106.

Referring to FIG. 9b, in an alternative configuration, the non-permeating fibers 327 can be fluidly isolated from the permeate cavity 110 by providing a fluid isolating obstruction 329 in the lumens. Such an obstruction 329 can be positioned in the lumens 112 anywhere at a point between the permeate cavity 110 and the expected breakpoint along the length of the fibers. Typically the position of the obstruction 329 would be adjacent the ends of the fibers near the potting resin 106 of the header 300. The obstruction 329 can be in the form of, for example, but not limited to, a bonded pinch seal or a plug. Such a plug can be provided by dipping the ends of the fibers 327 in a liquid resin and allowing the resin to cure or by ultrasonically welding the ends closed.

Alternatively, as best seen in FIG. 10, the non-permeating fibers 327 of the protective layer 325 can be solid fiber strands (filaments) 337. The solid filaments 337 can be constructed of, for example, a polyester yarn filament core 339 that is coated with a sleeve layer 341 of material similar to the material forming the permeating hollow fibers 104.

In use, the non-permeating fibers 327 of the protective layer 325 protect against breakage of the permeating fibers 104 by acting as sacrificial elements that can fracture or break without causing undesirable consequences, such as contamination of the permeate. As well, the protective layer can inhibit the occurrence of “stray” permeating fibers 104 potted in the header 300, since the permeating fibers 104 in the bundle 102 are gathered within the non-permeating fibers 327 of the outer protective layer 325. In other words, if any stray fibers were potted in the header 300, such a stray fiber would more likely be a non-permeating fiber 327, rather than a permeating fiber 104.

In use, it is expected that a certain proportion of the outermost fibers 327 in the header 300 will experience sufficient stress forces to cause those fibers 327 to fracture, rupture, or otherwise break. Since the fibers 327 in the outermost layer 325 are non-permeating, no contamination of the permeate results from such breakage. Furthermore, even if some of the fibers 327 in the layer 325 break, enough of the fibers 327 of the protective layer 325 can remain intact to provide sufficient breakage protection to the underlying permeating fibers 104. As well, any broken fibers may leave stubs emerging from the resin 106 that may continue to act as a cushioning wall 323. Stubs of non-permeating fibers may also be used as the protective layer 325. Ultimately, some of the permeating fibers 104 may also eventually break, but the protective layer 325 will have delayed the breakage, so that the mean operating time between servicing the module 92 has been extended.

Referring now to FIG. 11, an alternate protective layer 325a providing the cushioning wall 323 comprises reinforced hollow fibers 347. The reinforced hollow fibers 347 may be, for example, hollow fibers supported on a braided tube, having sufficient strength to resist breakage during normal use. The reinforced hollow fibers 347 can be permeating or non-permeating. In general, the reinforced hollow fibers 347 would be non-permeating, since the fibers 347 have a different construction compared to the permeating hollow fibers 104 in the bundles 102. These differences in construction could result in differences in filtration characteristics, and hence, contamination of the permeate collected through the permeating hollow fibers 104. However, if the reinforced fibers 347 are constructed to provide similar filtration characteristics as those of the permeating fibers 104, then the reinforced fibers 347 could also perform a permeating function.

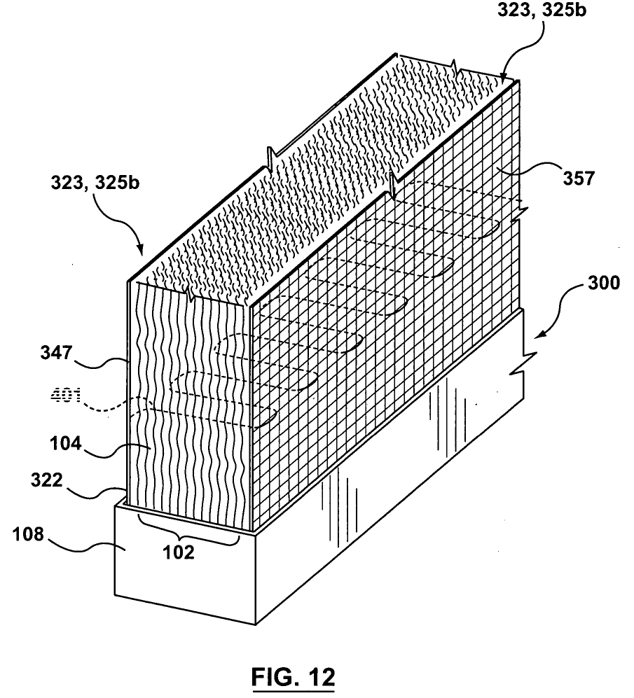

Referring now to FIG. 12, in another embodiment, the cushioning wall 323 is provided in the form of a protective layer 325b that comprises a fabric sheet 357. The fabric sheet 357 can be a porous textile sheet that permits transverse flow of non-permeated liquid to the interior permeating fibers 104 of the bundles 102. The sheet 357 can comprise, for example, but not limited to, cheesecloth, gauze, or a loosely woven fabric. In the embodiment illustrated, the wall 323 comprising the sheet 357 has a lower end 322 and an upper end 324 (not shown), each of which are potted in a header 300. The cushioning wall 323 extends between the lower and upper ends 322, 324, adjacent the outer fibers 104 of the bundle 102.

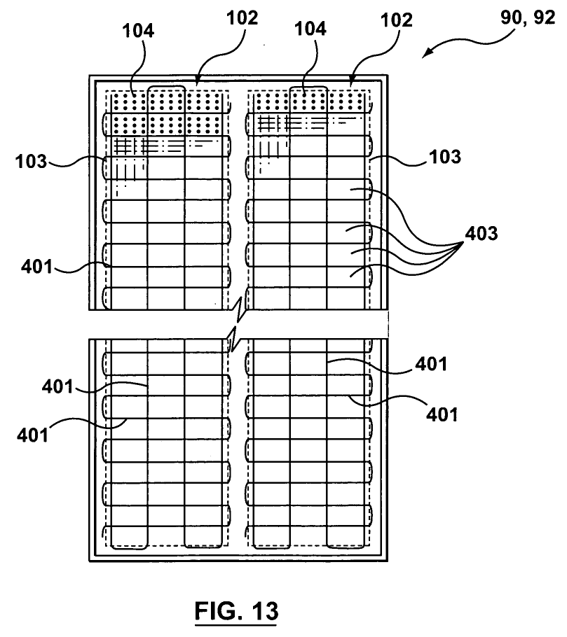

Referring now to FIG. 13, the modules 90, 92 according to the present invention can be provided with gathering elements 401 that extend around the perimeter 103 of the bundles 102 of permeating hollow fiber membranes 104. The gathering elements 401 can be provided to corral the ends of the hollow fiber membranes 104 before potting the membranes 104 in the header 100. The gathering elements 401 can be, for example, but not limited to, string elements such as hollow fibers, filaments, or yarn. The gathering elements 401 can be substantially inelastic or unstretched so as to avoid applying compressive forces on the bundles 102, and thereby maintain spaces between adjacent fibers 104 in the bundle 102. Maintaining space between the fibers 104 in the bundles 102 can facilitate the provision of resin 106 between adjacent fibers 104 in the bundle 102. By corralling the ends of the fibers 104, the gathering elements 401 can aid in preventing the occurrence of stray fibers potted in the resin 106. A stray fiber is a fiber 104 that emerges from the cured resin 106 in a position spaced apart from the main bundle 102 of fibers 104, such as, for example, between the perimeter 103 of the bundle 102 and the shell 108 of the header 100.

The gathering elements 401 can comprise yarn coarsely weaved in a plane perpendicular to the axis of the fibers 104. The grid pattern formed by the coarsely weaved gathering elements 401 can thereby provide sub-bundles 403 of fibers 104 within each bundle 102. Grouping the fibers 104 into sub-bundles can facilitate the corralling function of the gathering elements 401 in the bundle 102.

While preferred embodiments of the invention have been described herein in detail, it is to be understood that this description is by way of example only, and is not intended to be limiting. The full scope of the invention is to be determined by reference to the appended claims.

1. An apparatus comprising:
a) at least one bundle of permeating hollow fiber membranes that are potted in a block of a solid potting material; and
b) a cushioning wall along at least a portion of the axial length of the bundle of membranes adjacent the potting material, and around at least a portion of the perimeter of the bundle to help protect the fibers from breakage.

2. An apparatus according to claim 2 wherein the cushioning wall has a fixed edge adjacent the potting material, and the wall extends away from the potting material in a direction generally parallel to the axis of the hollow fiber membranes.

3. An apparatus according to claim 2, wherein the cushioning wall extends past the upper edges of any wicking asperities that may extend from the potting material.

4. An apparatus according to claim 2, wherein the fixed edge of the cushioning wall is attached to the potting material.

5. An apparatus according to claim 2, further comprising a shell in which the potting material is held, and the fixed edge of the cushioning wall is attached to the shell.

6. An apparatus according to claim 2 wherein the cushioning wall comprises a layer of formerly liquid material solidified in situ.

7. An apparatus according to claim 6 wherein the cushioning wall has a free edge opposite the fixed edge.

8. An apparatus according to claim 2, wherein the cushioning wall comprises a layer of protective fibers extending along substantially the entire axial length of the bundled permeating fibers.

9. An apparatus according to claim 2, wherein the layer cushioning wall comprises non-permeating fibers.

10. An apparatus according to claim 9 wherein the non-permeating fibers are hollow fibers having ends that terminate within, and are embedded within, the potting material.

11. An apparatus according to claim 9, wherein the non-permeating fibers are hollow fibers having fluid isolating obstructions within the fibers, between the ends of the non-permeating fibers and where the non-permeating fibers exit the potting material.

12. An apparatus according to claim 9, wherein the hollow fibers comprise solid filaments.

13. The header according to claim 12 wherein each solid filament has at least an outer layer of fiber material that is generally the same as the material from which the permeating hollow fiber membranes are constructed.

14. The header according to claim 9, wherein the layer of non-permeating fibers comprises reinforced permeating fibers with ends potted in the cured resin.

15. The header according to claim 8, wherein the layer of protective fibers comprises a porous fabric sheet extending along substantially the entire axial length of the bundled permeating fibers.

16. A method of constructing an assembly of potted filtering hollow fiber membranes, the method comprising the steps of:
a) supplying at least a first layer of potting material in the shell, the potting material having the ends of a bundle of permeating hollow fiber membranes potted therein; and
b) providing a cushioning wall along at least a portion of the axial length of the bundle and around at least a portion of the perimeter of the bundle to reduce stress on the fibers where the fibers exit the potting material.

17. The method of claim 16 wherein the cushioning wall is provided substantially along the entire perimeter of the bundle.

18. The method of claim 16 wherein step (b) comprises applying a solidifying liquid along the portion of the perimeter of the bundle and adjacent the potting material.

19. The method of claim 16 wherein the cushioning wall comprises a solid strip of flexible material having a fixed edge positioned to generally abut the first layer of potting material, and step (b) comprises supplying a second layer of potting material to pot the fixed edge of the sheath.

20. A method of potting hollow fiber membranes comprising the steps of:
a) arranging a plurality of hollow fiber membranes in a bundle;
b) providing gathering elements around the perimeter of the bundle of fibers and adjacent one end of the bundle;
c) inserting the one end of the bundle in a recess in a potting shell; and
d) providing a solidifying potting material in the shell between the bundle and the shell and between adjacent fibers in the bundle, such that the fibers of the bundle are potted in the shell as a collective group with minimal risk of potting stray fibers.

21. The method of claim 20 wherein the gathering elements are also provided between groups of fibers in the bundle to form sub-bundles.

22. The method of claim 21 wherein step (b) comprises weaving a coarse weave of yarn through the bundle in a plane generally perpendicular to the axis of the fibers.
